(19) United States
(12) Patent Application Publication
(10) Pub. No.: US 2003/0138287 A1
(43) Pub. Date: Jul. 24, 2003

(54) Structure of a file covering board or the like

(76) Inventors: Chyun-Chau Lin, Tainan (TW); Chien-Hsun Wu, Tainan (TW)

Correspondence Address: Chyun-Chau LIN, PO Box 82-144, TAIPEI, TW

(21) Appl. No.: 10/119,764

(22) Filed: Apr. 11, 2002

(30) Foreign Application Priority Data
Jan. 18, 2002 (TW) 091200409

(51) Int. Cl. B42F 13/00

(52) U.S. Cl. 402/73

(57) ABSTRACT

An improved structure of a file covering board is disclosed. The structure comprises an outer file covering board, an inner file covering board, a rivet means, a plurality of loose-leaf pages and an inner and outer spine. The outer file covering board is located at the external side of the inner file covering board and is secured using the rivet means. The two sides of the outer file covering board are provided with a cut section allowing a stable upright position. The middle section is provided with a foldable section having downward extended outer folding line. The combination region of the inner file covering board and the outer file covering board is provided with a bending section for offsetting potential difference and for increasing the strength of erection.

### BACKGROUND OF THE INVENTION

(a) Field of the Invention

The present invention relates to a file covering board, and in particular, to file covering board for files which contain a plurality of loose-leaf pages and stand upright on a platform or a flat surface.

(b) Description of the Prior Art

Conventional files for documentation or keeping data require flat board bodies as the file covers and a plurality of loose-leaf pages are disposed between the file covers. These files are normally placed horizontally and cannot be placed in an upright position. This is not convenient in application when the filed documents are needed and the user needs the file for typing and reading simultaneously. One of the hands is needed to hold the file so that the filed documents are in the upright position, which can be read by the user and the other hand is used for writing. In this case, the user can have only one hand to hold the file and at the same time another hand is used to write. This conventional file is not convenient in use and the file if has not been filed firmly will topple from the upright position thereof. Accordingly, it is the object of the present invention to provide an improved structure of a file, which can stand in an upright position, facilitating the documentation of file and usage of the filed documents.

### SUMMARY OF THE INVENTION

Accordingly, it is an object of the present invention to provide an improved structure of file covering board which can stand at an inclined angle to facilitate reading information/data filed in the file, comprising an outer file covering board, an inner file covering board, rivet means, loose-leaf pages, an inner and outer spine, the center of the inner and outer file covering board being provided with an inner and outer spine and the inner file covering board being provided with the loosen-leaf pages, characterized in that the inner file covering board is positioned at the inner side of the outer file covering board and the rivet means is used to mount the boards, the two sides of the outer file covering board is provided with a cut section for standing upright, and the middle section thereof is provided with a foldable section for supporting at an upright position, the combination section of the inner file covering board and the outer file covering board is provided with a bending section for offset potential difference and to strengthen erection of the file.

Yet another object of the present invention is to provide an improved structure of a file covering board or the like, wherein a foldable section positioned at the middle section of the outer file covering board is extended downward to form an outer bending line of various shapes.

A further object of the present invention is to provide an improved structure of a file covering board or the like, wherein the rivet means fixed at the inner and outer file covering board can be positioned in a left-right or up-down manner.

Another object of the present invention is to provide an improved structure of a file covering board or the like, wherein the foldable section of the inner file covering board and the outer covering board is provided with a bending section.

Still another object of the present invention is to provide an improved structure of a file covering board or the like, wherein the loose-leaf file within the inner file covering board can be mounted at the inner spine or at one side of the inner spine.

Other objects, and advantages of the present invention will become more apparent from the following description taken in conjunction with the accompanying drawings.

### BRIEF DESCRIPTION OF THE DRAWINGS

FIG. 1 is a perspective view showing the foldable outer board being not extended outward in accordance with the present invention.

FIG. 2 shows the top view of the file covering board at an extended position and at a retracted position in accordance with the present invention.

FIG. 3 is a side elevation view of the foldable outer board in accordance with the present invention.

FIG. 4 is a perspective view showing the foldable outer board being extended in accordance with the present invention.

FIG. 5 is a perspective view showing the arc line of the outer folding line being extended in accordance with the present invention.

FIG. 6 is a perspective view showing the circular arc of the outer folding line being extended in accordance with the present invention.

FIG. 7 is a perspective view showing the outer folding line being arc line and the middle section being extended in a opened flat manner in accordance with the present invention.

FIG. 8 is a perspective view showing the outer folding line being straight line and the middle section being extended in a opened flat manner in accordance with the present invention.

FIG. 9 is a perspective view showing the inner spine being provided with arc-shaped bending section in accordance with the present invention.

FIG. 10 is an extended perspective view, wherein the rivet means is located at the center thereof

FIG. 11 is a perspective view of the bending section, having a through hole, of the outer spine of FIG. 1 in accordance with the present invention.

FIG. 12 is a perspective view showing the loose-leaf positioned at the spine of the inner file covering board being extended in accordance with the present invention.

FIG. 13 is a perspective view showing the loose-leaf clip positioned at one side of the inner file covering board being extended in accordance with the present invention.

### DETAILED DESCRIPTION OF THE PRESENT INVENTION

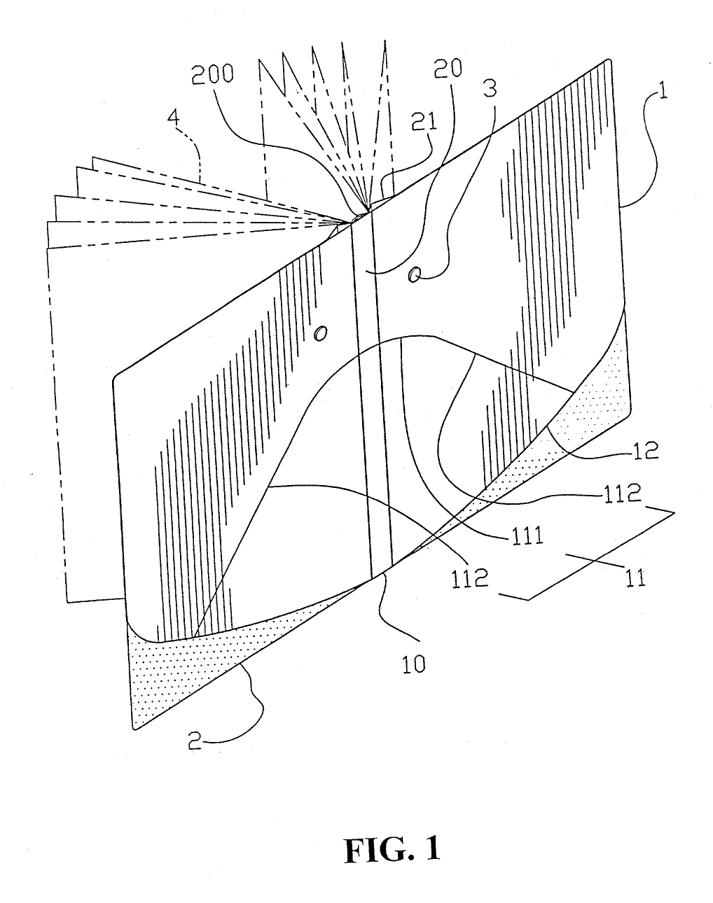

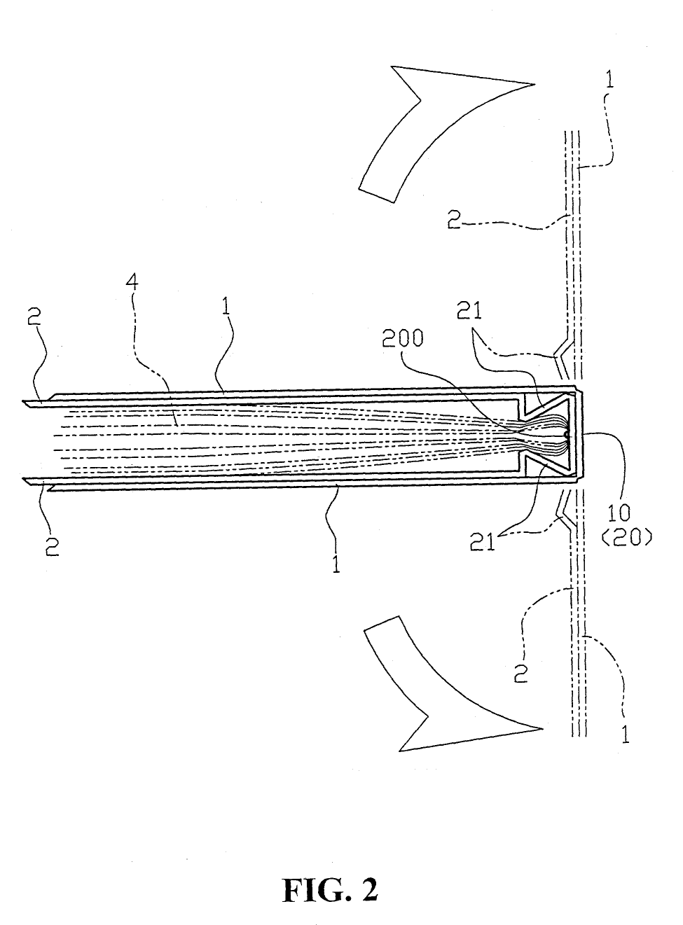

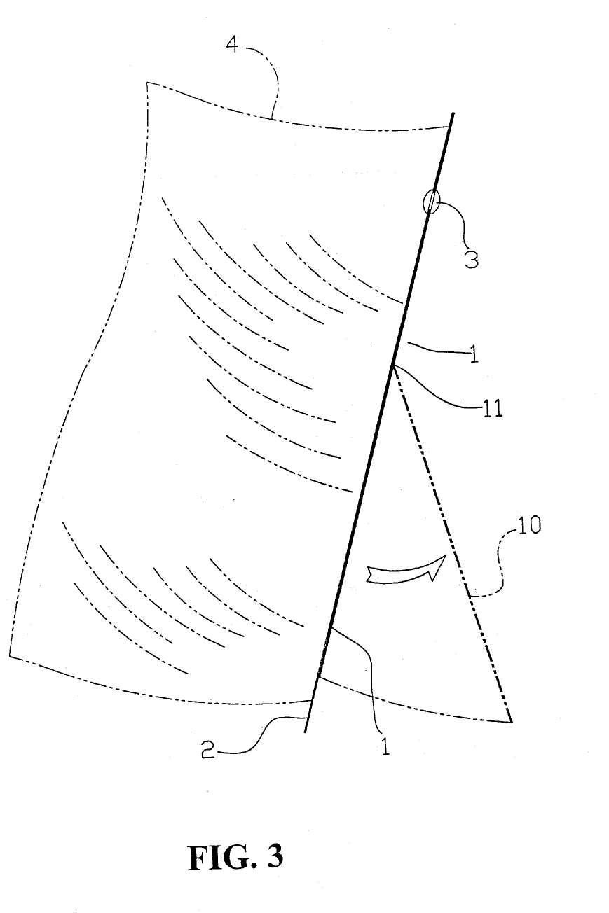

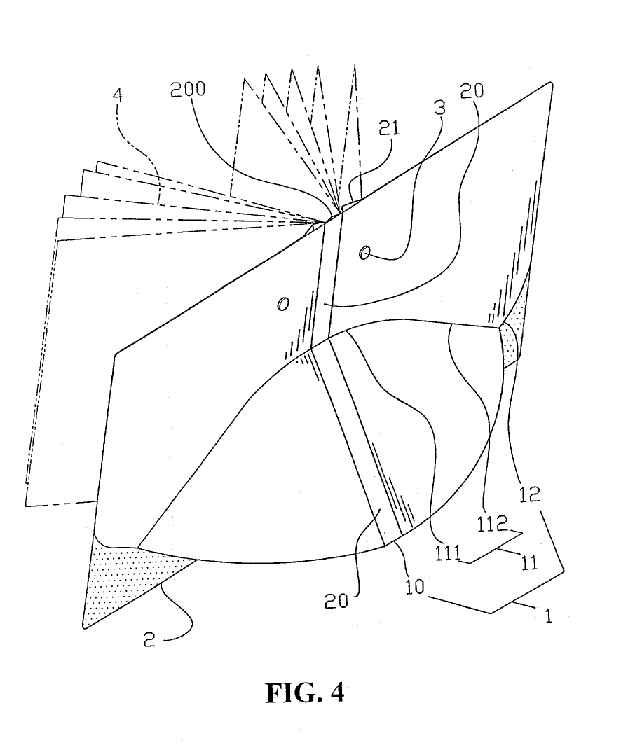

Referring to FIGS. 1 to 4, there is shown a perspective view of the outer board of the foldable section 10 being extended, a top view of the present invention, and a perspective view and side elevation view of the outer board of the foldable section 10 being extended. The present file covering board comprises an outer file covering board 1, an inner file covering board 2, a rivet means 3 for securing the two covering boards 1, and 2, a plurality of loose-leaf pages 4, and the inner spine 200 and outer spine 20. The outer file covering board 1 is positioned at the external side of the inner file covering board 2 and the two boards 1, 2 are fixed to each other by using the rivet means 3. In the present invention, the rivet means 3 is positioned at the two sides of the outer and inner file covering boards 1, 2. To provide stability of the file, the lower section at the left and right side of the outer file covering board 1 is provided with a cut section 12, and the middle section of the outer file covering board 1 is provided with a foldable section 10 having an outer folding line 11 for erection, the center of the inner and outer file covering board 2, 1, are provided with an inner and outer spines 200, 20, and the outer folding line 11 is located across the outer spine 20 and is extended downward, which is shown in FIGS. 1, 2, 3, and 4. The two sides of the outer folding line 11 are a straight section 112 and the middle section is an arc line section 111. In application as shown in FIGS. 3 and 4, the outer board of the foldable section 10 is extended and erected. When retracting, the procedures are the reversed. The foldable section 10 of the inner file covering board 2 and the outer file covering board 1 located at the two sides of the inner spine of the loose-leaf pages 4 is provided with bending section 21 of triangular shape. The bending section 21 is functioned to offset the potential difference of the inner and outer file covering boards 2, 1 during retraction and extension to achieve a balance. Without the bending section 21, the file covering boards 2, 1 cannot be retracted. The bending section 21 also provides a clipping function to the loose-leaf pages 4. When the present invention is extended, the outer file covering board 1 is urged, and when the foldable section 10 is folded, the inner spine 200 is upright.

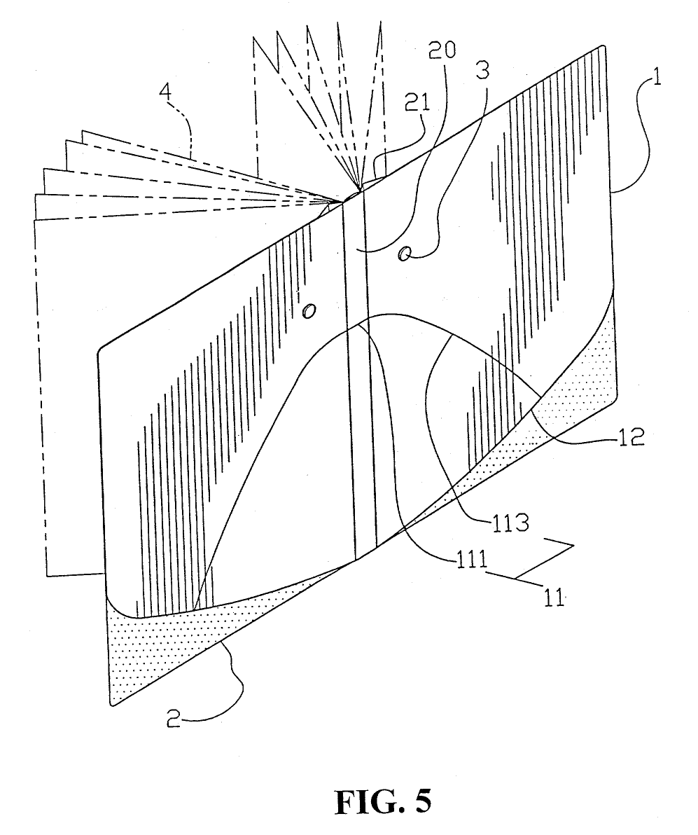

Referring to FIG. 5, there is shown a perspective view of the outer folding line 11 being an arc line 113, which is extended. That is, the straight line 112 section at the two sides is changed into the arc line 113.

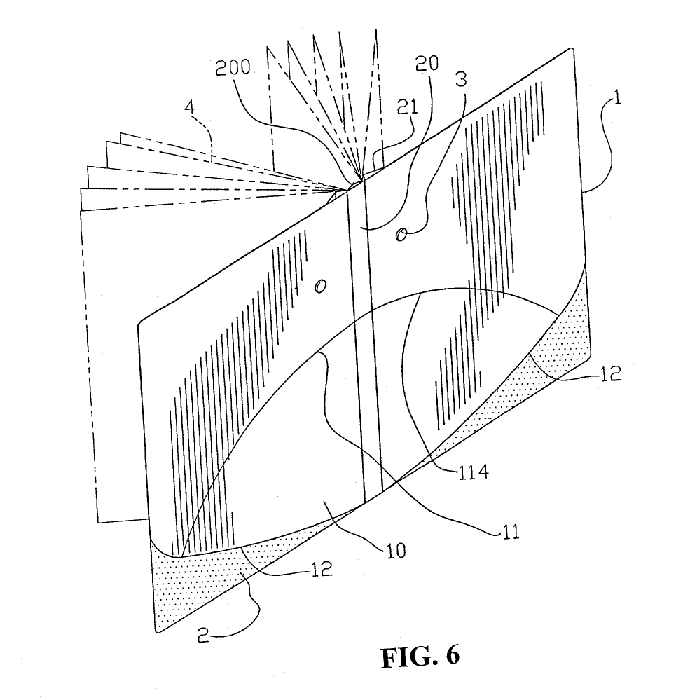

Referring to FIG. 6, there is shown a perspective view of the entire circular arc 114 of the outer folding line 11 being extended. The original straight line 112 section and the arc line section forming into the outer folding line 11 are designed into an entire circular arc 114.

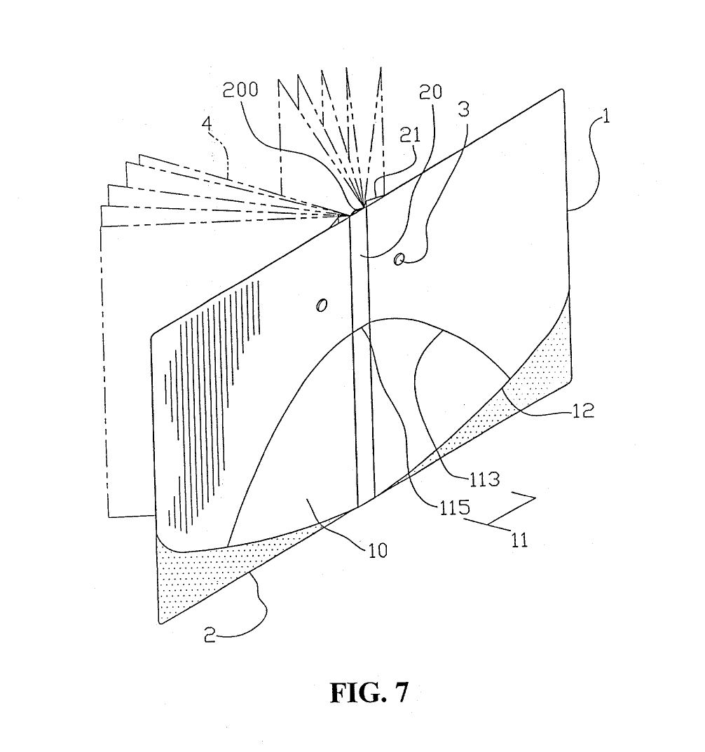

Referring to FIG. 7, there is shown a perspective view of the outer folding line 11 being arc line 113 and the middle section being a flat 115 section. That is, the originally straight line 112 section is designed into the arc line 113, and the originally arc line 111 is designed into a flat 115 section.

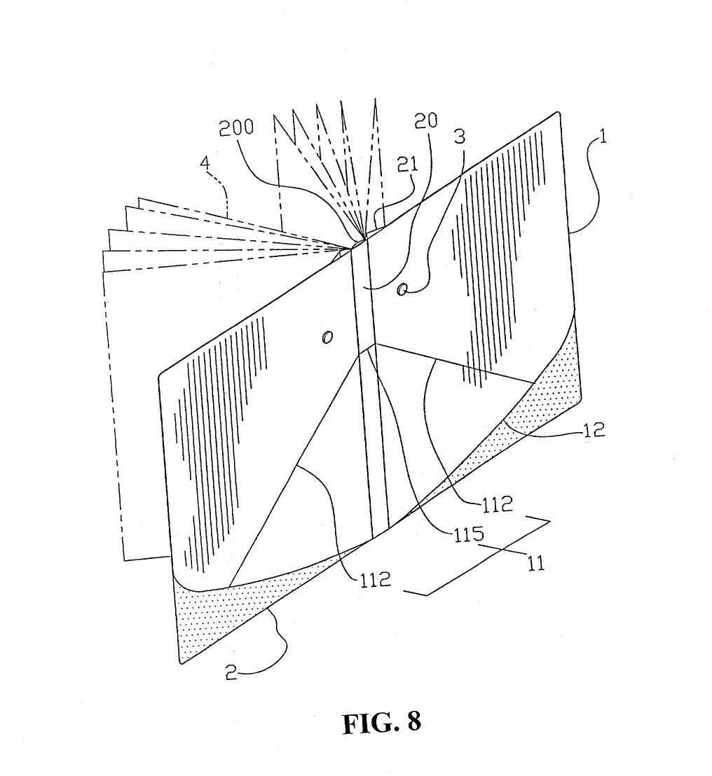

Referring to FIG. 8, there is shown a perspective view of the outer folding line 11 being a straight line 112 and the middle section being the flat 115 section. That is, the originally middle section arc line 111 is designed into a flat 115 section.

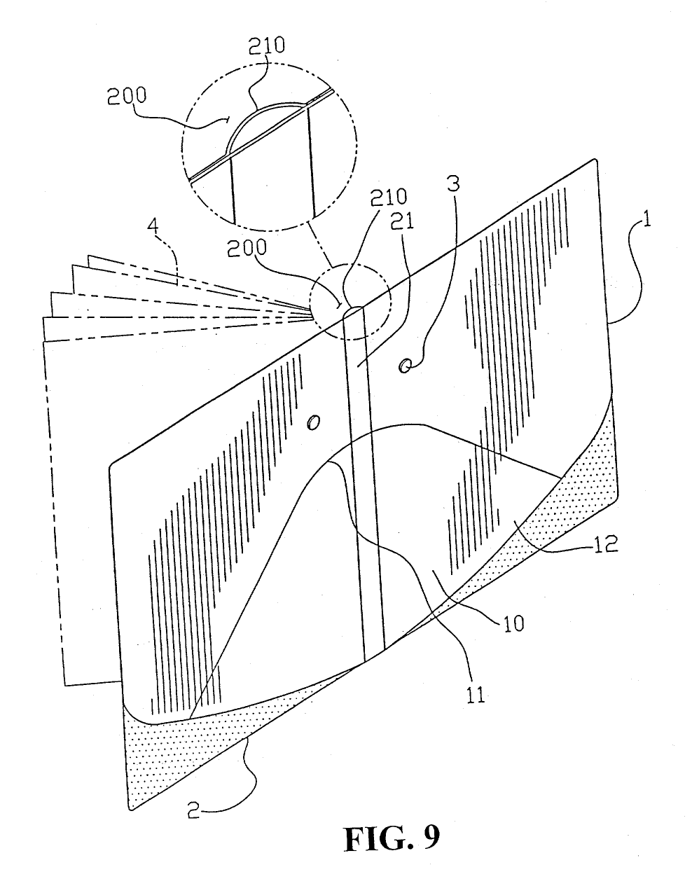

Referring to FIG. 9, there is shown a perspective view of the inner spine 200 of the inner file covering board 2 having an arc shape bending section 210. That is, the triangular bending section 21 at the two sides of the inner spine 200 is designed such that the inner spine 200 is an arc shape bending section 210.

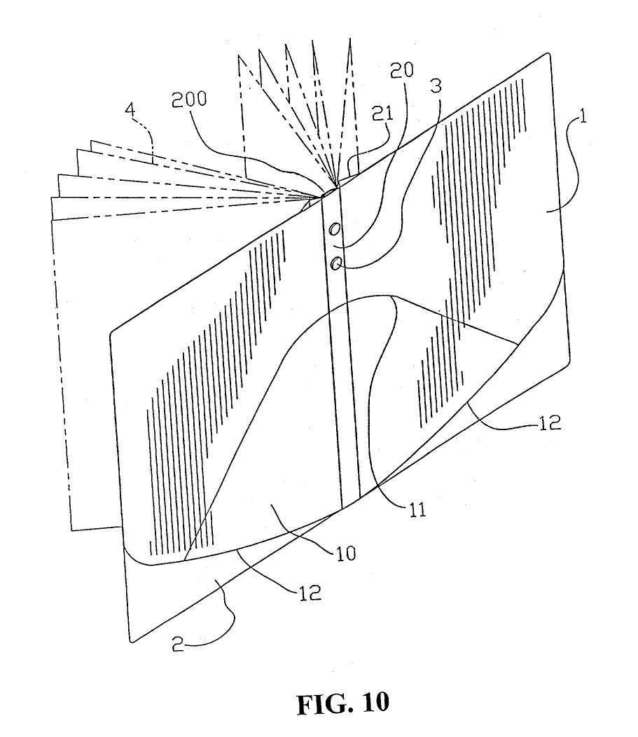

Referring to FIG. 10, there is shown a perspective view of the rivet means 3 located at the middle thereof. That is the horizontal rivet means 3 is made into straight to mount the outer spine 20 and the inner spine 200.

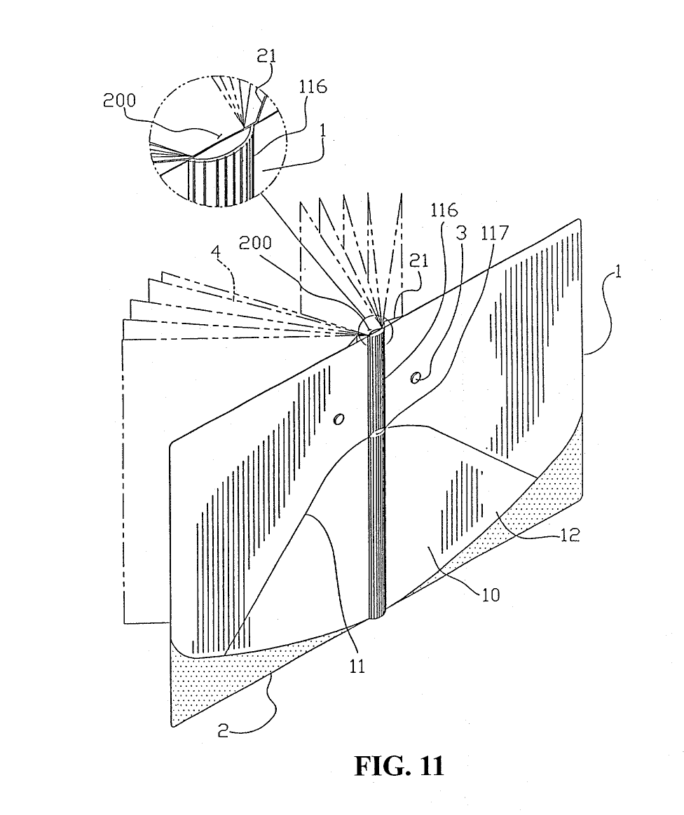

Referring to FIG. 11, there is shown a perspective view and a partial enlarge view of the outer spine bending section 116 having a through hole 117 of FIG. 1. That is the flat outer spine 20 is designed into an outer spine bending section 116 having an arc shape outer bending line, and at the crossing of the outer folding line 11, a through hole 117 is provided.

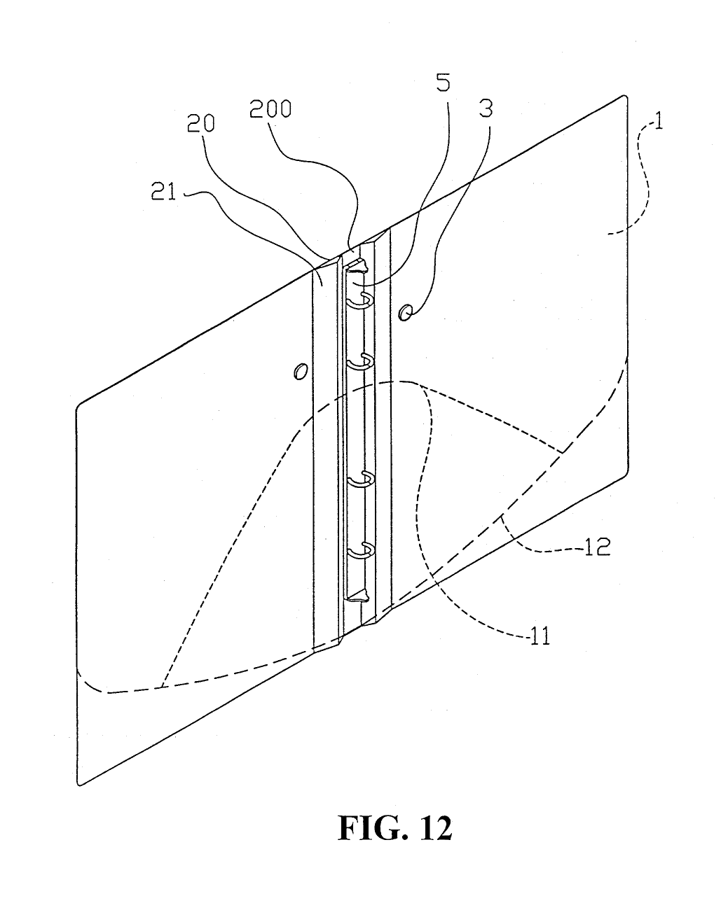

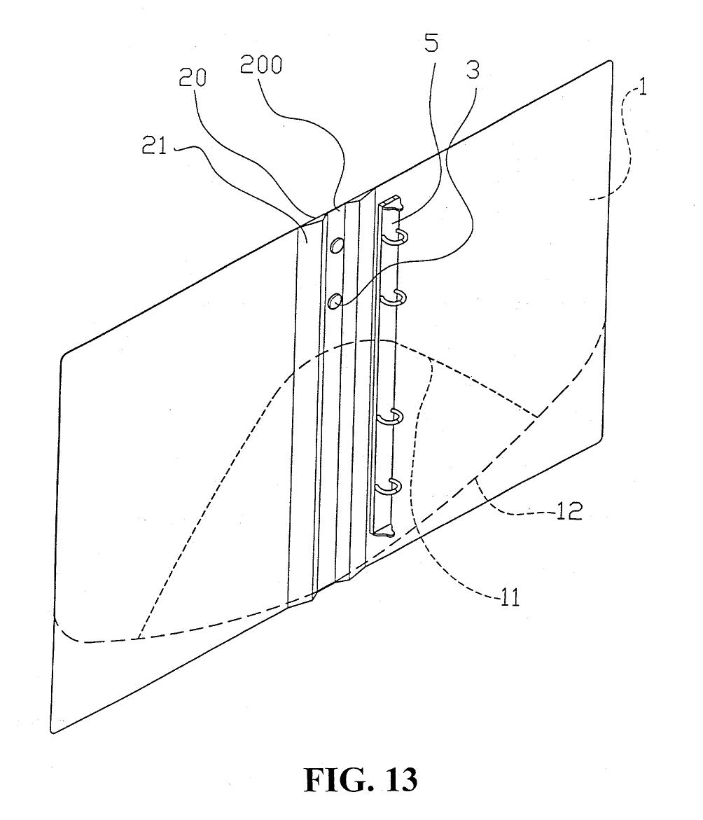

FIG. 12 is a perspective view showing the loosen-leaf clip 5 being located at the center of the inner file covering board 2. FIG. 13 is an exploded view showing the loose-leaf clip 5 being located at one side of the inner file covering board 2. That is the loosen-leaf clip 5 mounting the loosen leave-leaf 4 is positioned at the center of the inner spine 200 (as shown in FIG. 12), or the loosen-leaf clip 5 is positioned at one side of the inner file covering board 2 (as shown in FIG. 13).

In application, the outer board of the folding section 10 is extended and the file can be erected to stand on the surface of a table. When the file is retracted, the bending section 21 is stably held the loose-leaf pages 4 and the potential difference of the inner and outer file covering board 2, 1 at retraction and extension is offset. When extension, the bending section 21 can increase the upright strength of the inner spine 200. Besides, the arc shape bending section 210, the bending section 116 also provides offset the potential difference of the inner and outer file covering boards 2, 1 at retraction and extension.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. An improved structure of file covering board, which can stand at an inclined angle to facilitate reading information/data filed in the file, comprising an outer file covering board, an inner file covering board, rivet means, a plurality of loose-leaf pages, an inner and outer spine, the center of the inner and outer file covering board being provided with the inner and outer spine and the inner file covering board being provided with the loosen-leaf pages, characterized in that the inner file covering board is positioned at the inner side of the outer file covering board and the rivet means is used to mount the boards, the two sides of the outer file covering board are provided with a cut section facing an upright standing position, and the middle section thereof is provided with a foldable section for supporting at an upright position, the combination section of the inner file covering board and the outer file covering board is provided with a bending section for offset potential difference and to strengthen erection.

2. The file covering board of claim 1, wherein the two sides of the outer foldable line are straight line sections, and the middle section of the outer foldable line is an arc line section.

3. The file covering board of claim 1, wherein the two sides of the outer foldable line are arc line section and the middle section thereof is an arc line section.

4. The file covering board of claim 1, wherein the two sides and the middle section of the outer foldable line are circular arc.

5. The file covering board of claim 1, wherein the two sides of the outer foldable line are arc line sections and the middle section is a flat section.

6. The file covering board of claim 1, wherein the two sides of the outer foldable line are straight section, and the middle section is a flat section.

7. The file covering board of claim 1 wherein the rivet means for securing the inner, and the outer file covering board is mounted in a left right horizontal direction.

8. The file covering board of claim 1 wherein the rivet means for securing the inner, and the outer file covering board is mounted in an up-down vertical direction.

9. The file covering board of claim 1, wherein the bending section is located at the two sides of the inner spine and is a triangular shape.

10. The file covering board of claim 1, wherein the bending section is located at the two sides of the inner spine and is an arc shape structure.

11. The file covering board of claim 7, wherein the bending section is located at the two sides of the inner spine and is a triangular shape.

12. The file covering board of claim 8, wherein the bending section is located at the two sides of the inner spine and is a triangular shape.

13. The file covering board of claim 7, wherein the bending section is located at the two sides of the inner spine and is an arc shape structure.

14. The file covering board of claim 8, wherein the bending section is located at the two sides of the inner spine and is an arc shape.

15. The file covering board of claim 1, wherein the outer spine is provided with a bending section having an arc-shaped outer folding line, and the crossing region of the outer folding line is provided with a through hole.

16. The file covering board of claim 7, wherein the outer spine is provided with a bending section having an arc-shaped outer folding line, and the crossing region of the outer folding line is provided with a through hole.

17. The file covering board of claim 8, wherein the outer spine is provided with a bending section having an arc-shaped outer folding line, and the crossing region of the outer folding line is provided with a through hole.

18. The file covering board of claim 9, wherein the outer spine is provided with a bending section having an arc-shaped outer folding line, and the crossing region of the outer folding line is provided with a trough hole.

19. The file covering board of claim 10, wherein the outer spline is provided with a bending section having an arc-shaped outer folding line, and the crossing region of the outer folding line is provided with a through hole.

20. The file covering board of claim 11, wherein the outer spine is provided with a bending section having arc-shaped outer folding line, and the crossing region of the outer folding line is provided with a through hole.
